(19) United States
(12) Patent Application Publication
(10) Pub. No.: US 2015/0009495 A1
(43) Pub. Date: Jan. 8, 2015

(54) Method of Generating Raman Laser for Inducing Fluorescence of Pyrene and A System Thereof

(71) Applicant: Macau University of Science and Technology, Taipa (MO)

(72) Inventors: Jianqing LI, Taipa (MO); Ben XU, Taipa (MO)

(21) Appl. No.: 13/933,142

(22) Filed: Jul. 2, 2013

(51) Int. Cl. G01J 3/44

(52) U.S. Cl. CPC G01J 3/4406
USPC 356/301

(57) ABSTRACT

A method of generating Raman laser for inducing fluorescence of pyrene and a system thereof is disclosed. The system comprises a pulsed laser, a frequency doubling crystal, a frequency quadrupling crystal, a light filter unit, a Raman cell, a prism, an optical diaphragm, an object lens and an optical fiber. The method of the present invention comprises the steps of emitting a laser beam pulse through the crystals as mentioned above such that a mixture of lasers of different wavelength is generated. The light filter unit is used to obtain a pure pump laser from the mixture of lasers. Finally, the Raman laser is obtained by directing the pump laser into a Raman cell, extracting different orders of stimulated Raman scattering lasers emitted from the Raman cell by the prism and selecting a predetermined order of stimulated Raman scattering laser by the optical diaphragm.

### FIELD OF INVENTION

This invention relates to a method of generating Raman laser for detecting pyrene via laser-induced fluorescence; and a system of generating Raman laser for inducing fluorescence of pyrene.

### BACKGROUND OF INVENTION

Polycyclic aromatic hydrocarbons (PAHs) are hydrocarbon molecules containing two or more benzene rings. PAHs, which are classified as pollutants, include 150 kinds of compounds, for instance naphthalene, anthracene, phenanthrene, and pyrene. There are natural and anthropogenic sources for PAHs. The major sources of natural source are volcanic eruptions, forest fires and biosynthesis. On the other hand, incomplete combustion of a variety of fossil fuels (such as coal, oil, natural gas, etc.), wood, paper and any other hydrocarbon products contributes as the major source of anthropogenic source. PAHs in air, water and soil can contaminate the food, fruits and vegetables. It have already been confirmed by experiment that PAHs are carcinogenic, therefore, detection of PAHs is particularly important. Since pyrene is a kind of PAHs, it is important to detect it too. The concentration of pyrene in water is very low. Since pyrene has higher fluorescence quantum efficiency, it can be detected using fluorescence methods.

The Anhui Institute of Optics and Fine Mechanics of Chinese Academy of Sciences identified two relative strong fluorescence emission zones of pyrene utilizing F-7000 type fluorescence spectrophotometer. There are two comparatively stronger fluorescence intensity zones, which are located at λₑₓ/λₑₘ=240/372 nm and λₑₓ/λₑₘ=240/392 nm (as shown in FIG. 1), where λₑₓ and λₑₘ denote the wavelength of excitation and emission light, respectively. Therefore, the wavelength of the excitation light source is preferably to be 240 nm, or any neighboring values.

The simplest way to obtain an excitation light source with such excitation wavelength is to apply a spectrophotometer, which utilizes spectral elements such as prisms or gratings to split a continuous spectrum light source in order to isolate an excitation light with desired wavelength. This method is simple and direct, but the disadvantage is that the intensity of the output light is very low. Also the above method generally requires sampling and testing in the spectrometer or a spectrophotometer, which is not convenience while the spectrophotometer is in operation, which limits its scope of use.

Tunable ultraviolet laser source is an alternative way. Tunable ultraviolet laser sources have a certain wavelength tuning range, and the intensity of the output laser can usually fulfill the test requirements. However, the cost of the tunable laser source is high and thus is not popular. Moreover, if a tunable dye laser source is used, the carcinogenic dye in the tunable dye laser will be a threat against the health of the users.

Therefore there is a need to have a low-cost and stable laser source with suitable wavelength.

### SUMMARY OF INVENTION

The first objective of the present invention is to provide a method of making stable, low-cost, high intensity Raman laser with specific wavelength for inducing fluorescence of pyrene which overcomes the existing technical limitations.

The second objective of the present invention is to provide a system for generating Raman laser for inducing fluorescence of pyrene.

In one aspect of the present invention, a method of generating Raman Laser for inducing fluorescence of pyrene comprising the steps of: emitting a laser beam pulse; transmitting the laser beam pulse through a frequency doubling crystal and a frequency quadrupling crystal thereby generating a mixture of lasers of different wavelengths; extracting a pump laser from the mixture of lasers with different wavelengths; providing a Raman cell filled with predetermined gas at a predetermined pressure; directing the pump laser into the Raman cell thereby stimulating different orders of stimulated Raman scattering lasers; selecting a specific order of the stimulated Raman scattering laser.

In one embodiment, predetermined gas is hydrogen and said predetermined pressure is ranged from 0.6-0.8 MPa.

In another embodiment, the selecting step further comprises the step of dispersion said different orders of stimulated Raman scattering laser.

In another aspect of the present invention, a system of generating Raman laser for inducing fluorescence of pyrene comprising a pulsed laser configured to emit a laser beam pulse; a frequency doubling crystal and a frequency quadrupling crystal for the laser beam pulse to pass thorough thereby generating a mixture of lasers with different wavelengths; a light filter unit configured to extract a pump laser from the mixture of laser; a Raman cell filled with predetermined gas at a predetermined pressure configured to generate different orders of stimulated Raman scattering lasers upon interact with the pump laser; a dispersion device configured to separate the different orders of stimulated Raman scattering lasers spatially; and an optical diaphragm configured to select predetermined order of the stimulated Raman scattering laser from the different orders of stimulated Raman scattering lasers.

In one embodiment, the pulsed laser is a Nd:YAG pulsed laser.

In yet another embodiment, the light filter unit further comprises a first light filter and a second light filter, wherein each the first light filter and the second light filter comprises a mirror-like surface which is highly reflective to the pump laser.

The present invention has the following advantages comparing with the existing technologies:

The wavelength of the stimulated Raman scattering laser as provided by the method proposed by the present invention locates exactly at the peak of the excitation spectrum. Therefore it improves the accuracy of the detection and the stability of the system for inducing fluorescence of fluoranthene. Moreover, the Raman cell of the present invention is low cost which does not involve any thermal decomposition reaction yet stable even after long working hours. The method and system of the present invention thus improves the reliability of the generation of the stimulated Raman laser.

### BRIEF DESCRIPTION OF FIGURES

FIG. 1 shows the spectra of the excitation light and corresponding emission light of pyrene.

FIG. 2 shows the schematic diagram of a system of generating Raman laser for inducing fluorescence of pyrene according to one of the embodiment of the present invention.

### DETAILED DESCRIPTION OF THE PREFERRED EMBODIMENTS

As used herein and in the claims, “comprising” means including the following elements but not excluding others.

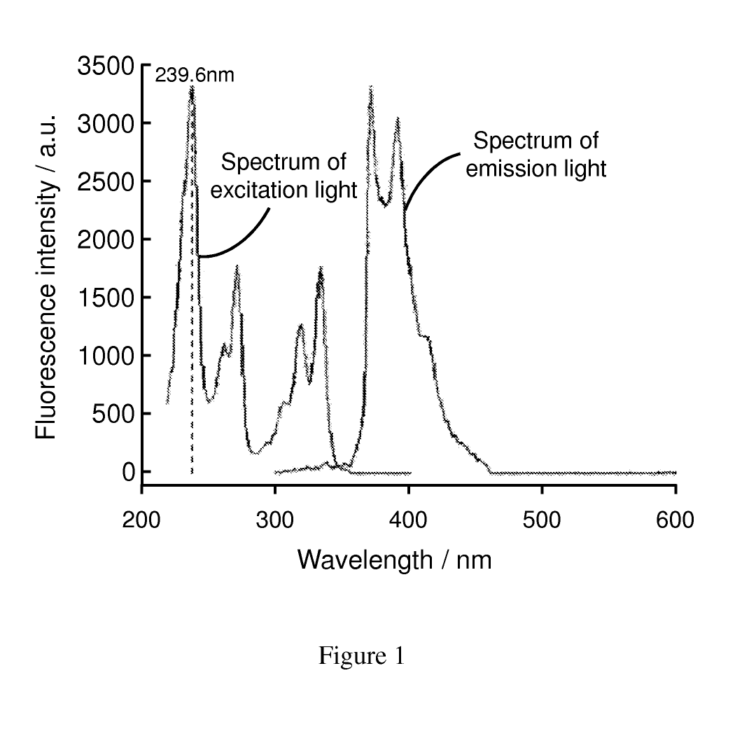

FIG. 1 shows the spectra of the excitation light and corresponding emission light of pyrene. As shown in FIG. 1, the excitation light has peak intensity at 240 nm which results in strong fluorescence intensity (emission light) from pyrene. The spectrum of the emission light has peak intensity at the wavelength around 392 nm.

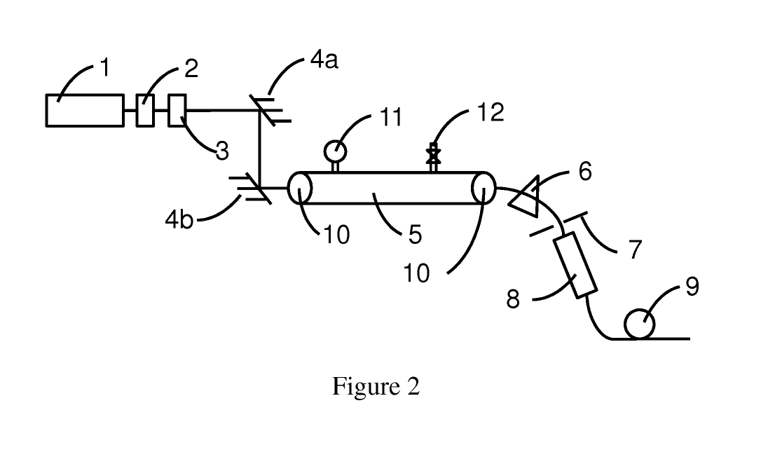

Referring to FIG. 2, the schematic diagram of a system of generating Raman laser for fluorescence spectroscopic detection of pyrene in one embodiment of the present invention. The system comprises a Nd:YAG pulsed laser 1; a frequency doubling crystal 2; a frequency quadrupling crystal 3; a light filter unit 4; a Raman cell 5; a prism 6; an optical diaphragm 7; an object lens 8; and an optical fiber 9. Convex lenses 10 are installed at the two ends of the Raman cell 5 acting as its two windows. The Raman cell 5 further comprises pressure gauge 11 for displaying the internal pressure and a valve 12 for controlling the air pressure therein.

In one embodiment, the frequency doubling crystal 2 is made of material selected from the group consisting of KDP crystal, KD*P crystal, and BBO crystal. In another embodiment, the frequency quadrupling crystal 3 is made of BBO crystal. The light filter unit 4 used in one embodiment of the present invention comprises a first light filter 4a and a second light filter 4b. Each light filter comprises a mirror face and the light filers are disposed such that the mirror faces are parallel to each other. The incident angle of the laser generated by the Nd:YAG pulsed laser 1 is 45° relative to the mirror faces of the first light filter 4a and the second light filter 4b when the laser is directed to them. The light filters are highly anti-reflective to laser with wavelength of 1064 nm and 532 nm; but highly reflective to fourth harmonic laser with wavelength of 266 nm. The Raman cell 5 is pressurized at a predetermined internal pressure. In one embodiment, the Raman cell 5 is filled with a hydrogen (H₂) gas. In another embodiment, the internal pressure of the Raman cell is at 0.6-0.8 MPa. In one embodiment, the convex lenses 10 installed at the two ends of the Raman cell 5 acts as its two windows and they are made of Ultraviolet (UV)-transparent quartz. In yet another embodiment, the focal lengths of the convex lenses 10 are about 30 cm. The optical diaphragm 7 is configured to select the laser with wavelength of interested by only allowing the laser at predetermined wavelength passing through an aperture. In one embodiment, the laser with wavelength of 239.6 nm is selected. In yet another embodiment, the object lens 8 is a convex lens.

Now turn to the method of generating Raman laser for inducing fluorescence of pyrene and the operation of the system of generating Raman laser for inducing fluorescence of pyrene in one embodiment of the present invention.

First, the Nd:YAG pulsed laser 1 is switched on to output a fundamental frequency laser with wavelength of 1064 nm. The fundamental frequency laser is then directed to pass thorough the frequency doubling crystal 2 and the frequency quadrupling crystal 3. As a result, a mixture of lasers comprising wavelength of 1064 nm, 532 nm and 266 nm is obtained, which are further directed to the light filter unit 4 in order to generate a pure linear polarized fourth harmonic laser with wavelength of 266 nm (i.e. pump laser). The fundamental frequency laser at 1064 nm and the second harmonic laser at 532 nm are filtered out by the light filters thereby resulting in the pump laser as an output of the light filter unit 4. Then, the pump laser is further directed into the Raman cell 5 thorough the first convex lens 10 of the Raman cell 5. The first convex lens is used to focus the pump laser into the Raman cell 5 to improve the power density of the pump laser for the stimulated Raman scattering. The Raman cell 5 helps to generate different orders of stimulated Raman scattering laser.

The following is the formula representing different orders of excited Raman scattering laser:

νₘ=νₚ+mν_{ν}

Wherein vₘ and νₚ denote the frequencies of the Raman scattering laser and pump laser, respectively, ν_{ν} denotes the vibrational Raman shift of H₂, m denotes the order of scattering laser and m=0, ±1, ±2, . . . , where negative numbers correspond to Stokes laser, positive numbers correspond to anti-Stokes laser, and 0 corresponds to residual pump laser.

In one embodiment, the frequency of the pump laser νₚ is 37,594 cm⁻¹ (i.e. 1/266 nm⁻¹). This is because the pump laser is fourth harmonic laser with wavelength of 266 nm. Furthermore, the vibrational Raman shift of H₂ is 4142 cm⁻¹.

Different orders of stimulated Raman scattering laser will be emitted when the H₂ in Raman cell is pumped by the fourth harmonic laser at 266 nm (i.e. pump laser). For instance, when m=1, the first anti-Stokes laser with wavelength of 239.6 nm will be produced.

Short focal length of the convex lenses 10 and low internal pressure of the Raman cell (e.g. 0.6-0.8 MPa) facilitate generation of the first anti-Stokes laser.

The prism 6 is disposed at the exit end of the Raman cell 5. The different orders of stimulated Raman scattering laser output from the Raman cell 5 is spatially separated (i.e. different light beams at different wavelengths). The optical diaphragm is then used to select the specific Raman scattering laser (m=1) at the exit side of the prism 6, i.e. laser with wavelength of 239.6 nm. Finally, the selected laser is coupled into optical fiber 9 through the object lens 8 to the output for fluorescence spectroscopy detection of pyrene.

The output intensity and converting efficiency of the 239.6 nm laser can be adjusted through altering the inner pressure of the Raman cell and modifying the focal length of the convex lenses 10.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

1. A method of generating Raman laser for inducing fluorescence of pyrene comprising the steps of:
a. emitting a laser beam pulse;
b. transmitting said laser beam pulse through a frequency doubling crystal and a frequency quadrupling crystal thereby generating a mixture of lasers with different wavelengths;
c. extracting a pump laser from said mixture of lasers;
d. providing a Raman cell filled with predetermined gas at a predetermined pressure;
e. directing said pump laser into said Raman cell thereby stimulating different orders of stimulated Raman scattering lasers; and
f. selecting a predetermined order of said stimulated Raman scattering laser as said Raman laser for inducing fluorescence of pyrene.

2. The method as claimed in claim 1, wherein said extracting step further comprising the step of passing a first light filter and second light filter.

3. The method as claimed in claim 1 wherein said predetermined gas is hydrogen and said predetermined pressure is ranged from 0.6-0.8 MPa.

4. The method as claimed in claim 1, wherein said directing step further comprises the step of directing said pump laser thorough a first convex lens before said pump laser reaches said Raman cell.

5. The method as claimed in claim 1, wherein said selecting step further comprises the step of spatially separation said different orders of Raman scattering laser.

6. A system of generating Raman Laser for inducing fluorescence of pyrene comprising
a. a pulsed laser configured to emit a laser beam pulse;
b. a frequency doubling crystal and a frequency quadrupling crystal for said laser beam pulse to pass thorough thereby generating a mixture of lasers with different wavelengths;
c. a light filter unit configured to extract a pump laser from said mixture of laser;
d. a Raman cell filled with predetermined gas at a predetermined pressure configured to generate different orders of stimulated Raman scattering lasers upon interact with said pump laser;
e. a light dispersion device configured to separate said different orders of stimulated Raman scattering lasers spatially; and
f. an optical diaphragm configured to select predetermined order of said stimulated Raman scattering laser from said different orders of stimulated Raman scattering lasers.

7. The system of claim 6, wherein said pulsed laser source is a Nd:YAG pulsed laser source.

8. The system of claim 6, wherein said light filter unit further comprises a first light filter and a second light filter, wherein each said first light filter and said second light filter comprises a mirror-like surface which is reflective to said pump laser.

9. The system of claim 8, wherein said first light filter and second light filter are disposed such that said minor faces are parallel to each other.

10. The system of claim 6, wherein said predetermined gas is hydrogen and said predetermined pressure is ranged from 0.6-0.8 MPa.

11. The system of claim 6 further comprising a first convex lens and a second convex lens, wherein said first convex lens is attached to a first end of said Raman cell and said second convex lens is attached to a second end of said Raman cell such that said first convex lens and said second convex lens act as the windows of said Raman cell.

12. The method of claim 4, wherein said first convex lens is attached to a first end of said Raman cell, and wherein said Raman cell further comprises a second convex lens which is attached to a second end of said Raman cell, such that said first convex lens and said second convex lens act as the windows of said Raman cell.
